(19) United States
(12) Patent Application Publication
(10) Pub. No.: US 2011/0182210 A1
(43) Pub. Date: Jul. 28, 2011

(54) ANONYMOUS COMMUNICATION SYSTEM

(76) Inventors: Natsuko Kagawa, Tokyo (JP); Takeaki Minamizawa, Tokyo (JP)

(21) Appl. No.: 13/056,263

(22) PCT Filed: Jul. 31, 2009
(86) PCT No.: PCT/JP2009/063638

§ 371 Date: Apr. 13, 2011

(30) Foreign Application Priority Data
Jul. 31, 2008 (JP) 2008-197944

(51) Int. Cl. H04L 12/16

(52) U.S. Cl. 370/259

(57) ABSTRACT

Provided is an anonymous communication system that allows an originator to determine the anonymous characteristics of communicating parties when communication is established. Disclosed is an anonymous communication system and an anonymous communication establishing apparatus to be installed in an anonymous communication system that are characterized enabling a communication by anonymity, said anonymous communication system detecting anonymities of communication parties when establishing a communication session, and notifying them to a communication device of a caller. Disclosed is an anonymous communication method that is enabling a communication by anonymity, said anonymous communication method detecting anonymities of communication parties when establishing a communication session, and notifying them to a communication device of a caller.

### TECHNICAL FIELD

The present invention relates to an anonymous communication system enabling an anonymous communication, and particularly an anonymous communication system that enables a caller to confirm its own anonymity and an anonymity of a communication partner when establishing a communication session.

### BACKGROUND ART

The so-called anonymous communication is a communication to be performed in a situation in which a caller does not reveal identification information for specifying itself to the communication partner. As one example, there exists a caller number notification/non-notification service by an IP communication network using voice described in Non-patent literature 1. In the caller number notification/non-notification service, adopting the caller number non-notification as a default setting at the time of a contract makes it possible to make a communication of not notifying a telephone number of a caller device to a callee device, namely, the anonymous communication. Further, in a telephone network of Japan, instead of making such a setting, for example, affixing “184” to the head of a destination telephone number and dialing up with the caller device makes it possible to make a communication of not notifying a telephone number of the caller device to the callee device, namely, the anonymous communication. On the other hand, adopting the caller number notification as the default setting at the time of a contract makes it possible to notify a telephone number of the caller device to the callee device. Further, in a telephone network of Japan, instead of making such a setting, for example, affixing “186” to the head of a destination telephone number and dialing up with the caller device makes it possible to notify a telephone number of the caller device to the callee device.

Further, the specific number notification service described in Non-patent literature 2 is also one kind of the anonymous communications. In this specific number notification service, when the caller becomes a contractor of the specific number notification service, not a separate telephone number of the caller device but a receiving charge telephone number (one kind of representative numbers) contracted by the caller can be notified to the callee device.

### CITATION LIST

### Non Patent Literature

[NPL 1] NIPPON TELEGRAM AND TELEPHONE WEST CORPORATION, “IP Communication Network Service Using Voice”, Edition 3.0, Feb. 1, 2007, pp. 11, Number Display (retrieved on Jul. 25, 2008), Internet<URL:http://www.ntt-west.co.jp/flets/hikaridenwa_office/download/hikari_office3.0.pdf>.

[NPL 2] NIPPON TELEGRAM AND TELEPHONE WEST CORPORATION, “Specific Number Notification Service”, (retrieved on Jul. 25, 2008), Internet <URL:http://www.ntt-west.co.jp/flets/hikaridenwa_office/service/bangoutuuchi/index.html>.

[NPL 3] TANIGUCHI Noboru, CHIDA Koji, SHIONOIRI Osamu, and KANAI Atsushi “A Note on Anonymity/Pseudonymity/Identity Management of Decentralized Identity Escrow,” IEICE Technical Report SITE2005-53, the Institute of Electronics, Information and Communication Engineers

[NPL 4] Andreas Pfitzmann and Marit Hansen “Anonymity, Unlinkability, Undetectability, Unobservability, Pseudonymity, and Identity Management—A Consolidated Proposal for Terminology (retrieved on Jul. 25, 2008), Internet<URL:http://dud.inf.tu-dresden.de/literatur/Anon_Terminology_v0.31.pdf>.

[NPL 5] The Free Encyclopedia ┌Wikipedia┘, “Anonymity”, (retrieved Jul. 25, 2008), Internet <URL:http://ja.wikipedia.org/wiki/%E5%8C%BF%E5%90%8D#E9.96.A2.E9.80.A3.E9.A0.85.E7.9B.AE>

### SUMMARY OF INVENTION

### Technical Problem

In the foregoing anonymous communication systems, a callee can confirm the anonymities of the communication parties at the time of establishing the communication session. However, a caller cannot confirm the anonymities of the communication parties. For this, for example, notwithstanding the caller number notification adopted actually as the default setting, the caller is convinced that the caller number non-notification has been adopted as the default setting, and dialing up without affixing “184”, whereby a mistake that the caller results in making a call without knowing this fact cannot be prevented.

Further, notwithstanding the representative number as a matter of fact, the caller is convinced that the telephone number is a specific personal telephone number, and dials up, whereby a mistake that the caller results in making a call without knowing this fact cannot be prevented.

An object of the present invention is to provide an anonymous communication system that enables the caller to confirm the anonymities of the communication parties when establishing the communication.

### Solution to Problem

The anonymous communication system of the present invention, which is an anonymous communication system enabling the communication by anonymity, detects the anonymities of the communication parties when establishing the communication session, and notifies them to the communication device of the caller.

The anonymous communication method of the present invention, which is an anonymous communication method enabling the communication by anonymity, detects the anonymities of the communication parties when establishing the communication session, and notifies them to the communication device of the caller.

The anonymous communication apparatus of the present invention, which is an anonymous communication establishing apparatus to be installed in an anonymous communication system enabling the communication by anonymity, detects the anonymities of the communication parties when establishing the communication session, and notifies them to the communication device of the caller.

The communication device of the present invention, which is a communication device in the anonymous communication system including: an anonymity managing means for retaining anonymity management information including a real addresses, an anonymous address, and an anonymity of the communication device; and an anonymous communication establishing means for establishing the communication session between the communication devices that includes: an anonymity management information acquiring means for acquiring the anonymity management information of the caller device and the anonymity management information of the callee device from the foregoing anonymity managing means when having received a communication connection request designating the callee device from the caller device; a notifying means for acquiring the anonymity of at least one of the caller device and the callee device from the foregoing acquired anonymity management information and notifying it to the caller device; and a communication establishing means for, when establishing the communication session between the caller device and the callee device, deciding which address, out of the real address and the anonymous address, should be used as an address of the caller device to be notified to the callee device responding to the anonymity of the caller device to be included in the foregoing acquired anonymity management information, receives a notification from the foregoing notifying means, and outputs notification contents in one of a character output form, a voice output form, and a vibration output form, or a plurality of output forms.

The communication device of the present invention, which is a communication device in the anonymous communication system including: an anonymity managing means for retaining anonymity management information including a real addresses, an anonymous address, and an anonymity of the communication device; and an anonymous communication establishing means for establishing the communication session between the communication devices that includes: an anonymity management information acquiring means for acquiring the anonymity management information of the caller device and the anonymity management information of the callee device from the foregoing anonymity managing means when having received a communication connection request designating the callee device from the caller device; a notifying means for acquiring the anonymity of at least one of the caller device and the callee device from the foregoing acquired anonymity management information and notifying it the caller device; a response receiving means for receiving a response to the notification by the above notifying means from the caller device; and a communication establishing means for deciding whether the communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in the foregoing acquired anonymity management information, includes: a means for receiving a notification from the foregoing notifying means, and outputting notification contents in one of a character output form, a voice output form, and a vibration output form, or a plurality of output forms; and a means for transmitting the response corresponding to the foregoing notification to the foregoing response receiving means.

The program of the present invention causes a computer to function as: an anonymity management information acquiring means for acquiring the anonymity management information of the caller device and the anonymity management information of the callee device from an anonymity managing means for retaining the anonymity management information including a real address, an anonymous address, and an anonymity of the communication device when having received a communication connection request designating the callee device from the caller device; a notifying means for acquiring the anonymity of at least one of the caller device and the callee device from the foregoing acquired anonymity management information and notifying it to the caller device; and a communication establishing means for, when establishing the communication session between the caller device and the callee device, deciding which address, out of the real address and the anonymous address, should be used as an address of the caller device to be notified to the callee device responding to the anonymity of the caller device to be included in the foregoing acquired anonymity management information.

The program of the present invention causes a computer to function as: an anonymity management information acquiring means for acquiring the anonymity management information of the caller device and the anonymity management information of the callee device from an anonymity managing means for retaining the anonymity management information including a real address, an anonymous address, and an anonymity of the communication device when having received a communication connection request designating the callee device from the caller device; a notifying means for acquiring the anonymity of at least one of the caller device and the callee device from the foregoing acquired anonymity management information and notifying it to the caller device; a response receiving means for receiving a response to the notification by the above notifying means from the caller device; and a communication establishing means for deciding whether the communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in the foregoing acquired anonymity management information.

The program of the present invention causes a computer constituting the communication device in the anonymous communication system including: an anonymity managing means for retaining the anonymity management information including a real address, an anonymous address, and an anonymity of the communication device; and an anonymous communication establishing means for establishing the communication session between the communication devices, which includes: an anonymity management information acquiring means for acquiring the anonymity management information of the caller device and the anonymity management information of the callee device from the foregoing anonymity managing means when having received a communication connection request designating the callee device from the caller device; a notifying means for acquiring the anonymity of at least one of the caller device and the callee device from the foregoing acquired anonymity management information and notifying it to the caller device; and a communication establishing means for, when establishing the communication session between the caller device and the callee device, deciding which address, out of the real address and the anonymous address, should be used as an address of the caller device to be notified to the callee device responding to the anonymity of the caller device to be included in the foregoing acquired anonymity management information, to function as a means for receiving a notification from the foregoing notifying means, and outputting notification contents in one of a character output form, a voice output form, and a vibration output form, or a plurality of output forms.

The program of the present invention causes a computer constituting the communication device in the anonymous communication system including: an anonymity managing means for retaining the anonymity management information including a real address, an anonymous address, and an anonymity of the communication device; and an anonymous communication establishing means for establishing the communication session between the communication devices, which includes: an anonymity management information acquiring means for acquiring the anonymity management information of the caller device and the anonymity management information of the callee device from the foregoing anonymity managing means when having received a communication connection request designating the callee device from the caller device; a notifying means for acquiring the anonymity of at least one of the caller device and the callee device from the foregoing acquired anonymity management information and notifying it to the caller device; a response receiving means for receiving a response to the notification by the above notifying means from the caller device; and a communication establishing means for deciding whether the communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in the foregoing acquired anonymity management information, to function as: a means for receiving a notification from the foregoing notifying means, and outputting notification contents in one of a character output form, a voice output form, and a vibration output form, or a plurality of output forms; and a means for transmitting the response corresponding to the foregoing notification to the foregoing response receiving means.

### Advantageous Effect of Invention

The present invention enables the caller to confirm the anonymities of the communication parties when establishing the communication session.

### BRIEF DESCRIPTION OF DRAWINGS

FIG. 1 is a block diagram of the anonymous communication system related to a first exemplary embodiment of the present invention.

FIG. 2 is a view illustrating an example of data stored in an anonymity management information storing unit in the first exemplary embodiment of the present invention.

FIG. 3 is a view illustrating one example of caller/callee anonymity management information in the first exemplary embodiment of the present invention.

FIG. 4 is an explanatory view of an operation of the anonymous communication system related to the first exemplary embodiment of the present invention.

FIG. 5 is a block diagram of main parts of the communication device in the first exemplary embodiment of the present invention.

FIG. 6 is a block diagram of the anonymous communication system related to a second exemplary embodiment of the present invention.

FIG. 7 is an explanatory view of an operation of the anonymous communication system related to the second exemplary embodiment of the present invention.

FIG. 8 is a block diagram of main parts of the communication device in the second exemplary embodiment of the present invention.

FIG. 9 is a view illustrating another example of data stored in the anonymity management information storing unit.

### DESCRIPTION OF EMBODIMENT

So as to explain the characteristics of the present invention, hereinafter, the characteristics of the present invention will be described specifically by making a reference to the accompanied drawings.

The first exemplary embodiment of the present invention will be explained in details by making a reference to the accompanied drawings.

### First Exemplary Embodiment

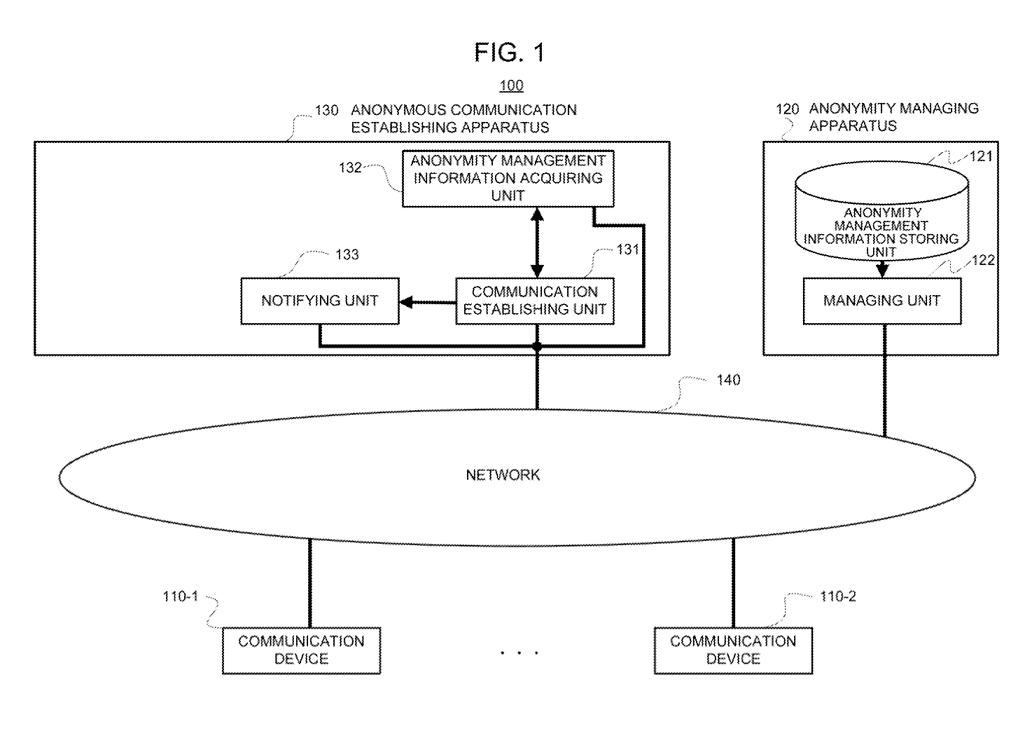

Upon making a reference to FIG. 1, in an anonymous communication system 100 related to the first exemplary embodiment of the present invention, a plurality of communication devices 110, an anonymity managing apparatus 120, and an anonymous communication establishing apparatus 130 are communicatably connected via a network 140.

The communication device 110 is a device in use for the anonymous communication, and specifically, an appliance having communication functions such as a mobile telephone machine and a personal computer. Two kinds of communication addresses of the real address and the anonymous address are assigned to each communication device 110.

The real address is an identifier for uniquely identifying the communication device 110, and specifically a separate telephone number, SIP-URI, or the like. A safety of the user might be jeopardized, for example, the user might receive unnecessary communications when the real address becomes known to a malicious third person because the real address is an identifier that the user cannot change easily.

The anonymous address is an identifier that is issued correspondingly to the real address. A correspondence relation between the real address and the anonymous address is managed in the anonymous communication system, and is not opened to the outside including the communication partner at the moment of the anonymous communication. For this, the real address of the user is not revealed from the anonymous address, and the anonymous communication in which a safety of the user is secured is enabled. Further, when the anonymous address becomes known to a malicious third person, annulling or changing the anonymous address makes it possible to secure a safety of the user without changing the real address.

The anonymity managing apparatus 120, which is an apparatus for retaining/managing anonymity management information of the communication device 110, includes an anonymity management information storing unit 121 and a managing unit 122.

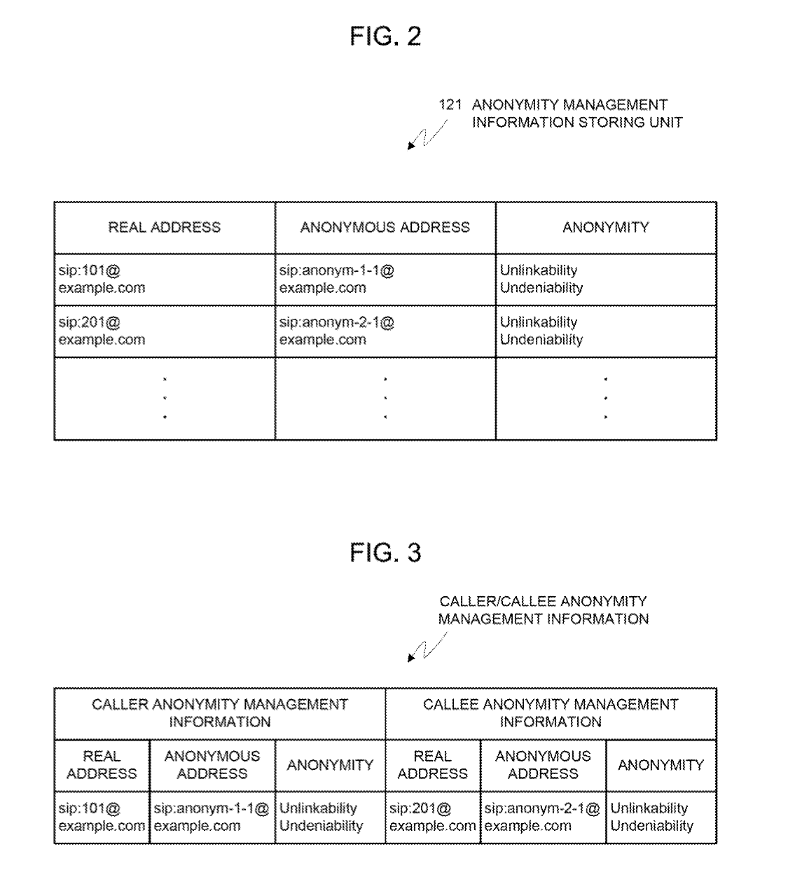

The anonymity management information storing unit 121 is a database for storing the anonymity management information for each communication device 110. The anonymity management information of each communication device 110 is configured of the real address assigned to the above communication device 110, the anonymous address issued correspondingly to this real address, and the anonymity. One example of the anonymity management information stored in the anonymity management information storing unit 121 is shown in FIG. 2.

The anonymity is information indicating at least whether the anonymous address is valid or invalid, and in addition, when the anonymous address is valid, one attribute or more characterizing the anonymity of the anonymous address may be described. As an example of the attribute characterizing the anonymity of the anonymous address, three concepts of identity, pseudonymity, and anonymity are defined in the Non-Patent literature 3. Further, six concepts of anonymity, unlinkability, undetectability, unobservability, pseudonymity, and identity are defined in the Non-Patent literature 4. In addition, two concepts of unlinkability and undeniability are defined in the Non-Patent literature 5. By the way, unlinkability refers to the property that who is an actor cannot be determined and besides, whether the actors having done certain two actions are an identical actor cannot be also determined, and undeniability refers to the property that a person cannot show a third party that the actor having done the above action is not me.

The managing section 122 of the anonymity managing apparatus 120 is a means for retrieving the corresponding anonymity management information from the anonymity management information storing unit 121 responding to a request for acquiring the anonymity management information by the anonymous communication establishing apparatus 130, and giving a response to the anonymous communication establishing apparatus 130.

The anonymous communication establishing apparatus 130, which is an apparatus for establishing the communication session between the communication devices 110, includes a communication establishing unit 131, an anonymity management information acquiring unit 132, and a notifying unit 133.

The communication establishing unit 131 is a means for establishing the communication session between the caller device and the callee device when a communication connection request designating the callee device is transmitted from the communication device 110 via the network 140. Further, the communication establishing unit 131 is a means for cancelling the established communication session at the time of finishing the communication. The communication establishing unit 131 acquires the anonymity management information of the caller device and the anonymity management information of the callee device from the anonymity managing apparatus 120 through the anonymity management information acquiring unit 132 when establishing the communication session. Further, the communication establishing unit 131 decides which address, out of the real address and the anonymous address, should be used as an address of the caller device to be notified to the callee device responding to the anonymity of the caller device to be included in the acquired anonymity management information. Additionally, in a case where the anonymous addresses are present in a plural number, the communication establishing unit 131 decides which address should be notified when having decided to notify the anonymous address.

Further, prior to the establishment of the communication session, the communication establishing unit 131 prepares the caller/callee anonymity management information including the anonymity management information of the caller device as the caller anonymity management information and the anonymity management information of the callee device as the callee anonymity management information each received from the anonymity management information acquiring unit 132, and transmits this caller/callee anonymity management information to the notifying unit 133. One example of the caller/callee anonymity management information is shown in FIG. 3.

The anonymity management information acquiring unit 132 is a means for transmitting a request for acquiring the anonymity management information of the caller device and the anonymity management information of the callee device via the network 140 to the anonymity managing apparatus 120 according to an instruction by the communication establishing unit 131, receiving the anonymity management information to be sent as a response hereto from the anonymity managing apparatus 120, and conveying it to the communication establishing unit 131.

The notifying unit 133 is a means for notifying the anonymities of the communication parties that make the communication with each other through the communication session to be established by the communication establishing unit 131 to the communication device 110 of the caller of the above communication. The notifying unit 133, upon receipt of the caller/callee anonymity management information from the communication establishing unit 131, executes one action of a, b, and c mentioned below.

(a) The notifying unit 133 generates notification information including the anonymity of the caller device extracted from the caller anonymity management information, and transmits it via the network 104 to the caller device that is identified with the real address within the caller anonymity management information.

(b) The notifying unit 133 generates notification information including the anonymity of the callee device extracted from the callee anonymity management information, and transmits it via the network 104 to the caller device that is identified with the real address within the caller anonymity management information.

(c) The notifying unit 133 generates notification information including the anonymity of the caller device extracted from the caller anonymity management information, and the anonymity of the callee device extracted from the callee anonymity management information, and transmits it via the network 104 to the caller device that is identified with the real address within the caller anonymity management information.

Which action, out of a, b, and c, is done is decided for example, by the system setting. Hereinafter, the explanation will be continued on the assumption that a is decided by the system setting.

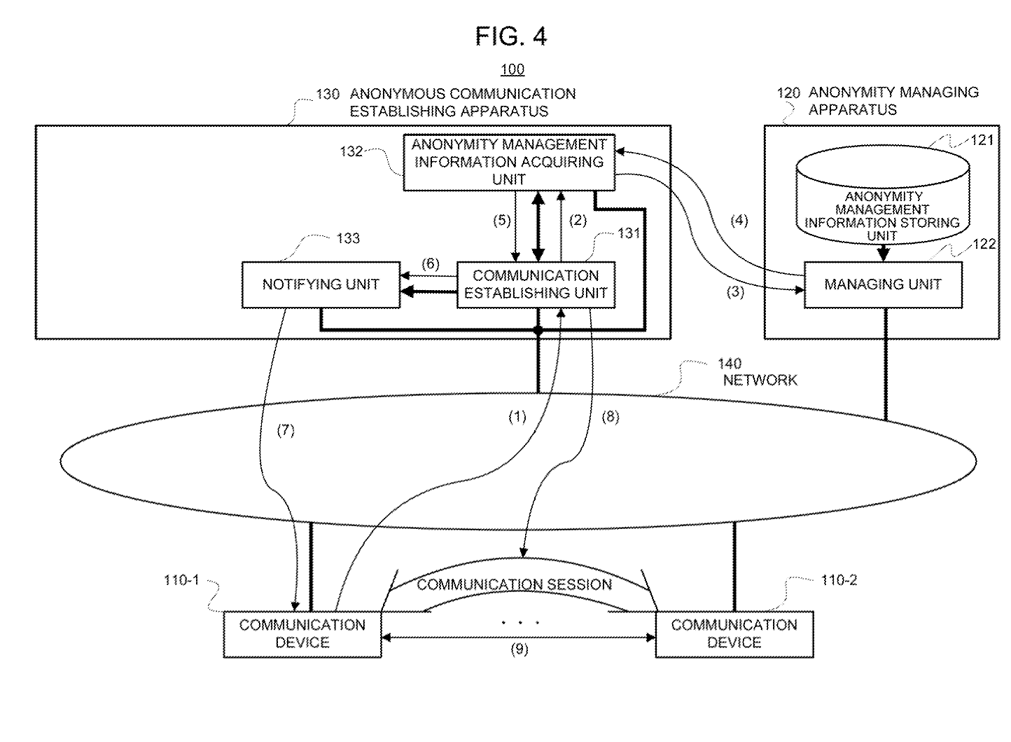

Next, an exemplary operation of the anonymous communication system 100 related to this exemplary embodiment will be explained by making a reference to FIG. 4. A scheme of transmitting the anonymities of the communication parties to the communication device 110-1 when establishing the communication session in which the communication device 110-1 becomes a caller device and the communication device 110-2 becomes an callee device is listed as an example. Herein, it is assumed that the user of the communication device 110-1 is A, the real address is sip:101@example.com, the anonymous address is sip:anonym-1-1@example.com, and the anonymity is unlinkability & undeniability, and that the user of the communication device 110-2 is B, the real address is sip:201@example.com, the anonymous address is sip:anonym-2-1@example.com, and the anonymity is unlinkability & undeniability.

When the user A performs a call manipulation to the user B over the communication device 110-1, a communication connection request is transmitted to the communication establishing unit 131 of the anonymous communication establishing apparatus 130 via the network 140 from the communication device 110-1 ((1) of FIG. 4). In this communication connection request, for example, the real address of the communication device 110-1 is included as information for specifying the communication device 110-1, being a caller device, and for example, the anonymous address of the communication device 110-2 is included as information for specifying the communication device 110-2, being a callee device.

The communication establishing unit 131 delivers the real address of the caller device and the anonymous address of the callee device that are included in the communication connection request to the anonymity management information acquiring unit 132, and makes a request for acquiring the caller anonymity management information and the callee anonymity management information ((2) of FIG. 4).

The anonymity management information acquiring unit 132 transmits a request for acquiring the anonymity management information including the real address of the caller device and a request for acquiring the anonymity management information including the anonymous address of the callee device to the managing unit 122 of the anonymity managing apparatus 120 via the network 140 ((3) of FIG. 4).

The managing unit 122 retrieves the anonymity management information including the real address identical to that of the caller device, and the anonymity management information including the anonymous address identical to that of the callee device from the anonymity management information storing unit 121, and transmits the discovered anonymity management information to the anonymity management information acquiring unit 132 via the network 140 ((4) of FIG. 4). The anonymity management information acquiring unit 132 conveys the received anonymity management information to the communication establishing unit 131 ((5) of FIG. 4). As a result, it follows that the anonymity management information of the first line shown in FIG. 2 as the caller anonymity management information, and the anonymity management information of the second line shown in FIG. 2 as the callee anonymity management information are delivered to the communication establishing unit 131.

The communication establishing unit 131 generates the caller/callee anonymity management information including the received caller anonymity management information and callee anonymity management information, and transmits it to the notifying unit 133 ((6) of FIG. 4).

The notifying unit 133 notifies the anonymity of the caller to the communication device 110-1 based upon the received caller/callee anonymity management information ((7) of FIG. 4). Specifically, with the case of the caller/callee anonymity management information of FIG. 3, notification information including the anonymity unlinkability & undeniability of the caller anonymity management information is generated, and transmitted via the network 104 to the communication device 101-1 of the caller that is specified with the real address sip:101@example.com.

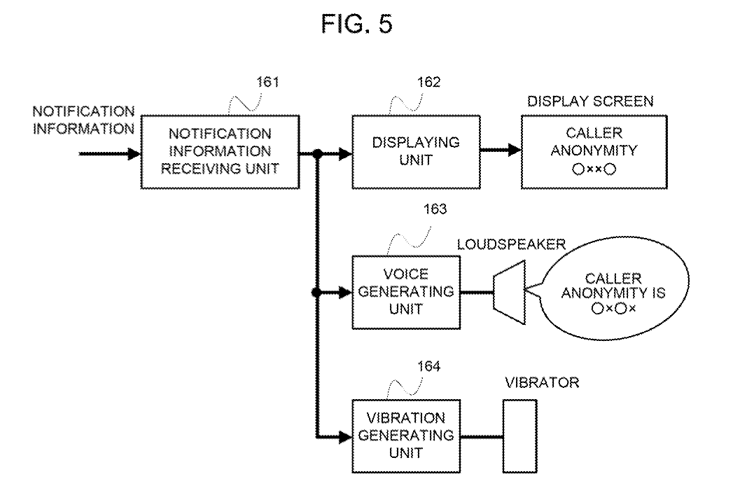

The communication device 110-1, upon receipt of the notification information, presents the notification information to the user A. As a method of presenting the notification information, one of the method of displaying on the display screen, the method of outputting in a voice or sound form, and the method of outputting in a vibration form may be used, and a combination thereof may be used. One example of a configuration of presenting the notification information is shown in FIG. 5. In this example, a notification information receiving unit 161 receives the notification information from the notifying unit 133, and conveys it to a displaying unit 162, a voice generating unit 163 and a vibration generating unit 164. The displaying unit 162 displays the anonymity of the caller device notified with the notification information on the displaying screen such as a liquid crystal display. Further, the voice generating unit 163 outputs the similar content in a voice form from the voice output element such as a loudspeaker. In addition, the vibration generating unit 164 notifies the anonymity to the user A by vibrating a vibrator with a vibration pattern caused to correspond to each anonymity on a one-to-one basis.

After the communication establishing unit 131 notifies the caller/callee anonymity management information to the notifying unit 133, it tries to establish the communication session. At first, the communication establishing unit 131 confirms that the anonymity within the caller anonymity management information is unlinkability & undeniability, and decides to use the anonymous address as an address of the caller device that is notified to the callee device. Next, the communication establishing unit 131 reads out the real address of the communication device 110-2, being a callee device, from the callee anonymity management information, conceals the real address of the communication device 110-1, being a caller device, from the communication device 110-2, being a callee device, notifies the anonymous address within the caller anonymity management information instead thereof, and establishes the communication session between the communication device 110-1 and the communication device 110-2 ((8) of FIG. 4). This allows the communication device 110-1 and the communication device 110-2 to start the communication through the above communication session ((9) of FIG. 4).

Next, an effect of this exemplary embodiment will be explained.

This exemplary embodiment enables the user of the caller device to confirm its own anonymity and the anonymity of the communication partner when establishing the communication session.

Further, according to this exemplary embodiment, the user of the caller device does not need to perform a specific manipulation in order to receive the notification of the anonymities of the communication parties because the anonymities of the communication parties are notified in a form of making a response to the communication connection request transmitted by the user of the caller device. This can previously prevent the carelessness that, for example, notwithstanding the caller number notification adopted actually as the default setting, the caller is convinced that the caller number non-notification has been adopted as the default setting, dials up without affixing “184” signifying the caller number non-notification in a telephone network of Japan, and makes a call without knowing this fact. Further, this can previously prevent the carelessness that notwithstanding the representative number as a matter of fact, the caller is convinced that the telephone number is a specific personal telephone number, dials up, and makes a call without knowing this fact.

### Second Exemplary Embodiment

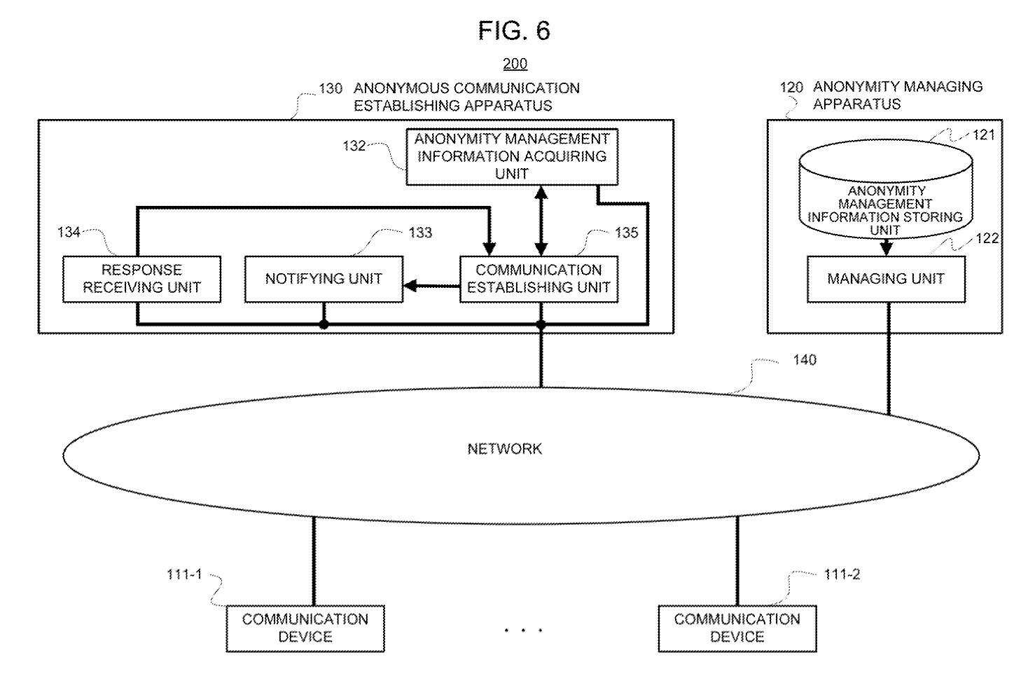

Upon making a reference to FIG. 6, an anonymous communication system 200 related to the second exemplary embodiment of the present invention differs in a point of newly including a response receiving unit 134 within the anonymous communication establishing apparatus 130, in a point of including a communication establishing unit 135 instead of the communication establishing unit 131, and in a point of including communication devices 111 instead of the communication devices 110 as compared with the anonymous communication system 100 related to the first exemplary embodiment shown in FIG. 1, and is identical in other points to the anonymous communication system 100 related to the first exemplary embodiment.

The communication device 111 has an function of selectively transmitting one of a permission response indicating that the establishment of the communication session is permitted, and a no-permission response indicating that the establishment of the communication session is not permitted as a response to the notification by the notifying unit 133 of the anonymous communication establishing apparatus 130 besides an function of the communication device 110 of the first exemplary embodiment.

The response receiving unit 134 is a means for receiving a response to the notification by the notifying unit 133 from the communication device 111, and notifying it to the communication establishing unit 135.

The communication establishing unit 135 has a function of deciding whether or not the communication session should be established responding to a response result by the communication device 111 to be notified from the response receiving unit 134 besides an function of the communication establishing unit 131 of the first exemplary embodiment. Specifically, the communication establishing unit 135 establishes the communication session only when the response is a permission response.

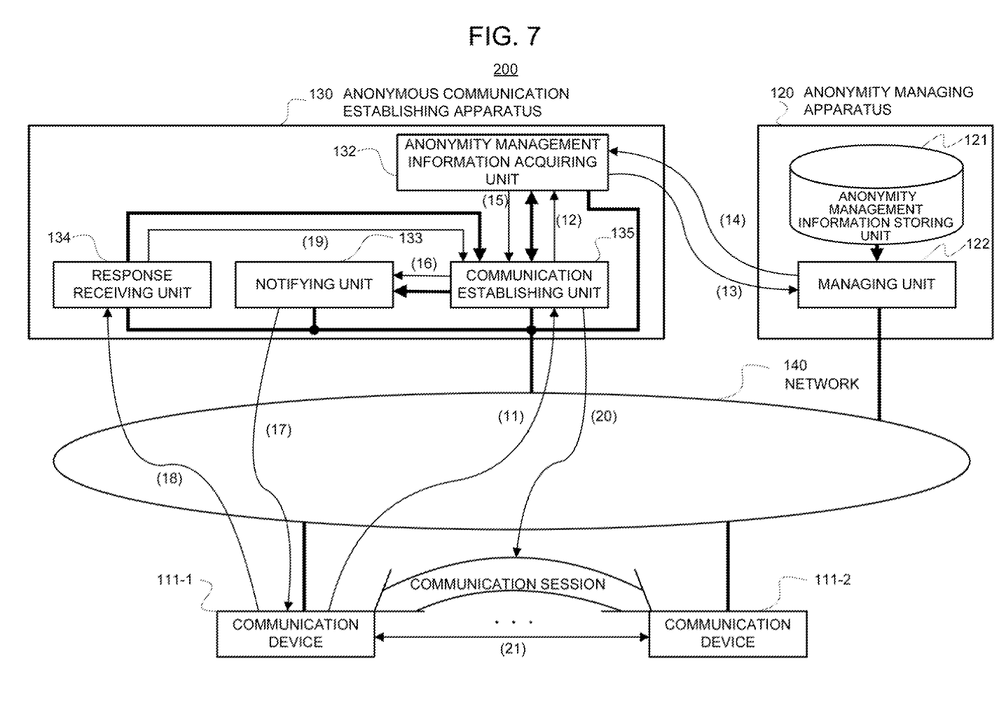

Next, an exemplary operation of the anonymous communication system 200 related to this exemplary embodiment will be explained by making a reference to FIG. 7. A scheme of transmitting the anonymities of the communication parties to the communication device 111-1 when establishing the communication session in which the communication device 111-1 becomes a caller device, and the communication device 111-2 becomes a callee device is listed as an example, similarly to the case of the first exemplary embodiment

When the user A performs a call manipulation to the user B over the communication device 111-1, a communication connection request is transmitted to the communication establishing unit 135 of the anonymous communication establishing apparatus 130 via the network 140 from the communication device 111-1 ((11) of FIG. 7). In this communication connection request, for example, the real address of the communication device 111-1 is included as information for specifying the communication device 111-1, being a caller device, and for example, the anonymous address of the communication device 111-2 is included as information for specifying the communication device 111-2, being a callee device.

The communication establishing unit 135 delivers the real address of the caller device and the anonymous address of the callee device that are included in the communication connection request to the anonymity management information acquiring unit 132, and makes a request for acquiring the caller anonymity management information and the callee anonymity management information ((12) of FIG. 7).

The anonymity management information acquiring unit 132 transmits a request for acquiring the anonymity management information including the real address of the caller device and a request for acquiring the anonymity management information including the anonymous address of the callee device to the managing unit 122 of the anonymity managing apparatus 120 via the network 140 ((13) of FIG. 7).

The managing unit 122 retrieves the anonymity management information including the real address identical to that of the caller device, and the anonymity management information including the anonymous address identical to that of the callee device from the anonymity management information storing unit 121, and transmits the discovered anonymity management information to the anonymity management information acquiring unit 132 via the network 140 ((14) of FIG. 7). The anonymity management information acquiring unit 132 conveys the received anonymity management information to the communication establishing unit 135 ((15) of FIG. 7). As a result, it follows that the anonymity management information of the first line shown in FIG. 2 as the caller anonymity management information, and the anonymity management information of the second line shown in FIG. 2 as the callee anonymity management information are delivered to the communication establishing unit 135.

The communication establishing unit 135 generates the caller/callee anonymity management information including the received caller anonymity management information and callee anonymity management information, and transmits it to the notifying unit 133 ((16) of FIG. 7). And, the communication establishing unit 135 waits the response to the notification being sent from the response receiving unit 134.

The notifying unit 133 notifies the anonymity of the caller to the communication device 111-1 based upon the received caller/callee anonymity management information ((17) of FIG. 7). Specifically, with the case of the caller/callee anonymity management information of FIG. 3, the notification information including the anonymity unlinkability & undeniability of the caller anonymity management information is generated, and transmitted via the network 104 to the communication device 111-1 of the caller that is specified with the real address sip:101@example.com.

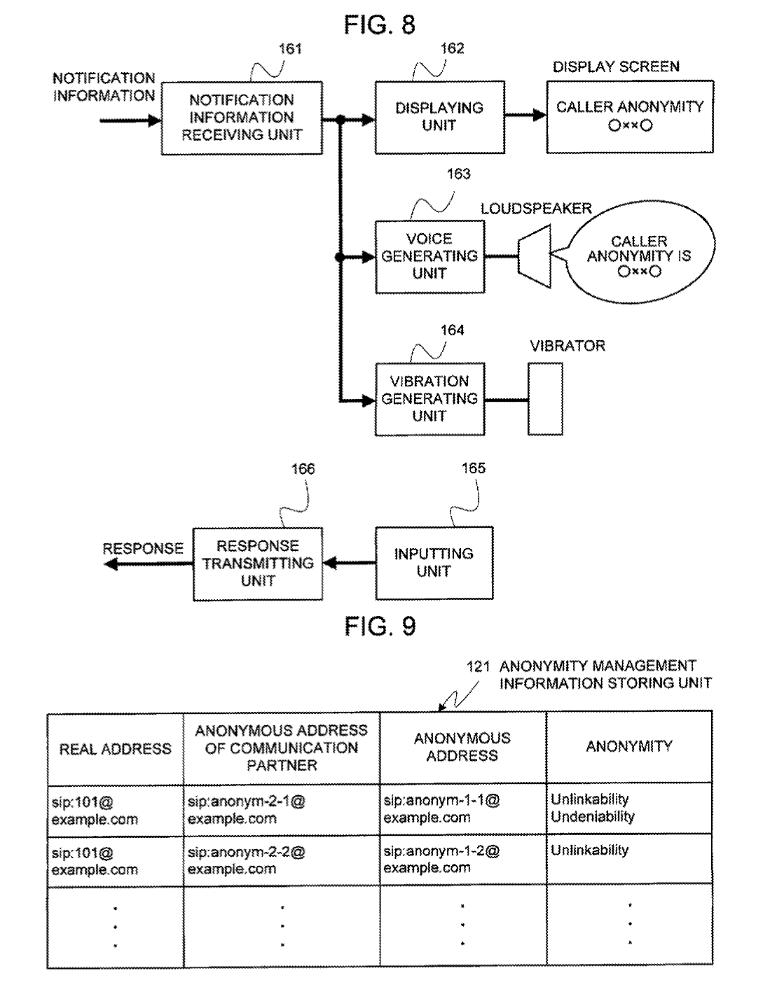

The communication device 111-1, upon receipt of the notification information, presents the notification information to the user A. As a method of presenting the notification information, one of the method of displaying on the display screen, the method of outputting in a voice or sound form, and the method of outputting in a vibration form may be used, and a combination thereof may be used. Configurations shown in FIG. 5 and FIG. 8 similar hereto can be used as a configuration of presenting the notification information. Upon making a reference to FIG. 8, an inputting unit 165 such as a keyboard and a response transmitting unit 166 are installed into the communication device 111-1. The user A confirms its own anonymity and the anonymity of the communication partner from the displaying screen etc. displaying the content of the notification information received from the notifying unit 133 of the anonymous communication establishing apparatus 130, inputs an instruction for permission from the inputting unit 165 when no problem exists, and inputs an instruction for no-permission when a problem exists. The response transmitting unit 166 generates response information including the inputted instruction, and transmits it to the response receiving unit 134 of the anonymous communication establishing apparatus 130 via the network 140 ((18) of FIG. 7).

The response receiving unit 134 of the anonymous communication establishing apparatus 130, upon receipt of the response from the communication device 111-1 via the network 140, notifies the received response to the communication establishing unit 135 ((19) of FIG. 7).

When, after notifying the caller/callee anonymity management information to the notifying unit 133, the communication establishing unit 135 receives the no-permission response from the response receiving unit 134, it does not establish the communication session. On the other hand, when receiving the permission response from the response receiving unit 134, the communication establishing unit 135 tries to establish the communication session. Additionally, after the caller/callee anonymity management information is notified to the notifying unit 133, when no response is made by the response receiving unit 134 within a certain time, it may be judged that the no-permission response has been made, and to the contrary, it may be judged that the permission response has been made.

When trying to establish the communication session, the communication establishing unit 135 firstly confirms that the anonymity within the caller anonymity management information is unlinkability & undeniability, and decides to use the anonymous address as an address of the caller device to be notified to the callee device. Next, the communication establishing unit 135 reads out the real address of the communication device 111-2, being a callee device, from the callee anonymity management information, conceals the real address of the communication device 111-1, being a caller device, from the communication device 111-2, being a callee device, notifies the anonymous address within the caller anonymity management information instead thereof, and establishes the communication session between the communication device 111-1 and the communication device 111-2 ((20) of FIG. 7). This allows the communication device 111-1 and the communication device 111-2 to start the communication through the above communication session ((21) of FIG. 7).

Next, an effect of this exemplary embodiment will be explained.

Simultaneously with obtaining an effect similar to that of the first exemplary embodiment, this exemplary embodiment makes it possible to establish the communication session after obtaining permission by the caller device user having confirmed the anonymities of the communication parties. With this, for example, in a case where, notwithstanding the caller number notification adopted actually as the default setting, the caller is convinced that the caller number non-notification has been adopted as the default setting and dials up without affixing “184” signifying the caller number non-notification in a telephone network of Japan to the head of the number, the caller issues a no-permission response at a time point of having known this fact from the notification information, thereby enabling the useless communication session to be prevented from being established. Further, in a case where, notwithstanding the representative number as a matter of fact, the caller is convinced that the telephone number is a specific personal telephone number and dials up, the caller issues a no-permission response at a time point of having known this fact from the notification information, thereby enabling he useless communication session to be prevented from being established.

### Other Exemplary Embodiments

The present invention is not limited to the exemplary embodiments mentioned above, and the following various additions/modifications hereto are enabled.

While the explanation was made in the exemplary embodiments mentioned above on the assumption that the anonymous address corresponding to the real address of the communication device was pre-generated and stored in the anonymity managing apparatus 120, it may be dynamically generated. In this case, for example, a function of generating the anonymous address from the real address of the communication device is installed into the managing unit 122 of the anonymity managing apparatus 120. When having received a request for acquiring the anonymity management information including the real address from the anonymity management information acquiring unit 132 of the anonymous communication establishing apparatus 130, the managing unit 122 generates the anonymous address having a desired anonymity from the received real address, registers the anonymity management information, which is configured of the real address, the foregoing generated anonymous address, and the anonymity, to the anonymity management information storing unit 121, and simultaneously therewith, transmits it to the anonymity management information acquiring unit 132 in a case where the corresponding anonymity management information does not exist in the anonymity management information storing unit 121, or in a case where the anonymous address different from the previous one needs to be generated even though the corresponding anonymity management information exists because the anonymity is, for example, unlinkability.

While the explanation was made in the exemplary embodiments mentioned above on the assumption that the anonymity management information of all of the communication devices was managed by one anonymity managing apparatus 120, they may be dispersedly managed by a plurality of the anonymity managing apparatuses 120.

While one anonymous communication establishing apparatus 130 recognized the real address of the caller communication device and the real address of the callee communication device, and established the communication session between both of the communication devices, a plurality of the anonymous communication establishing apparatuses may sharedly establish the communication session so that the real addresses of both of the caller and the callee do not become known to one anonymous communication establishing apparatus. Specifically, a first anonymous communication establishing apparatus having received the communication connection request including the real address of the caller and the anonymous address of the callee from the communication device of the caller establishes the communication session with the communication device that is specified with the real address of the caller, and transmits the anonymous address of the communication device of the callee, and the anonymous address of the caller within the anonymity management information of the caller acquired from the anonymity managing apparatus to a second anonymous communication establishing apparatus. The second anonymous communication establishing apparatus acquires the anonymity management information including the real address corresponding to the anonymous address of the callee from the anonymity management information, and establishes the communication session with the communication device that is specified with the real address of the callee. Finally, the communication session established by the first anonymous communication establishing apparatus, and the communication session established by the second anonymous communication establishing apparatus are linked, and the communication session in use for the communication between the caller and the callee is generated.

While the explanation was made in the exemplary embodiments mentioned above on the assumption that the anonymous address of the communication device corresponded to the real address on a one-to-one basis, a plurality of the anonymous addresses may correspond to one real address. In this case, all of the anonymities may coincide with each other, and the anonymities may differ from each other partially or completely. Further, the anonymous addresses may be used properly according to the anonymous address of the communication partner. FIG. 9 shows an example of the anonymity management information in which two anonymous addresses of sip:anonym-1-1@example.com and sip:anonym-1-2@example.com correspond to the communication device having sip:101@example.com as a real address. In this example, the setting is made so that sip:anonym-1-1@example.com is used when the anonymous address of the communication partner is sip:anonym-2-1@example.com, and sip:anonym-1-2@example.com is used when the anonymous address of the communication partner is sip:anonym-2-2@example.com. In a case of using such anonymity management information, for example, when making a request for acquiring the anonymity management information including the real address of the communication device of the caller, the anonymous communication establishing apparatus 130 designates the anonymous address (for example, it is assumed that the anonymous address is sip:anonym-2-1@example.com) as well of the callee, being a communication partner, during the request. The managing unit 122 of the anonymity managing apparatus 120 retrieves the anonymity management information having the real address sip:101@example.com of the caller designated by the acquirement request, and yet having the anonymous address of the communication partner (callee) designated during the request from the anonymity management information storing unit 121. Thus, with the case of FIG. 9, the anonymity management information of the first line is retrieved and sent to the anonymous communication establishing apparatus 130.

While the case that the caller device make the anonymous communication with the other one communication device was explained, it is also possible for one caller device to simultaneously make the anonymous communications with a plurality of the other communication devices. At that moment, as shown in FIG. 9, the different anonymous address may be used for each communication partner. At this time, when requests for making connections to a plurality of the other communication devices are simultaneously given by the above one caller device, for all of the anonymous communications between the above one caller device and each of a plurality of the other communication devices, the anonymities of the above communication parties (either the caller or the callee, or both thereof) may be notified to the caller device.

While the case that the caller device make one anonymous communication with the other one communication device was explained, it is also possible for one caller device to simultaneously establish a plurality of the communication sessions with the other one communication device, and to simultaneously make a plurality of the anonymous communications by using the anonymous addresses each having the identical anonymity, or the anonymous addresses each having the different anonymity for each anonymous communication. At this time, when requests for making connections to a plurality of the other communication devices are simultaneously given by the above one caller device, for all of the anonymous communications between the above one caller device and each of the other communication devices, the anonymities of the above communication parties (either the caller or the callee, or both thereof) may be notified to the caller device. At this time, the anonymous addresses in use for individual anonymous communications, and session identifiers, which are given to respective communication sessions by the anonymous communication establishing apparatus 130 in order to identify individual anonymous communications, may be notified together therewith.

Further, while, needless to say, each function that the anonymous communication establishing apparatus, the anonymity managing apparatus, and the communication device have can be realized in a hardware manner, it can be realized with a computer and a program.

In the system of the anonymous communication that is make between the communication devices such as the mobile telephone machines via Internet and Next Generation Network (NGN), the present invention is applicable to the system in which the caller device confirms its own anonymity and the anonymity of the communication partner when establishing the communication session, and the method thereof.

As mentioned above, a first aspect of the present invention, which is an anonymous communication system enabling a communication by anonymity, is characterized in detecting anonymities of communication parties when establishing a communication session, and notifying them to a communication device of a caller.

A second aspect of the present invention is characterized in, in the above-mentioned aspect, including: an anonymity managing Means for retaining anonymity management information including a real address, an anonymous address and an anonymity of a communication device; and an anonymous communication establishing means for establishing a communication session between the communication devices, wherein the anonymous communication establishing means includes: an anonymity management information acquiring means for acquiring anonymity management information of a caller device and anonymity management information of a callee device from the foregoing anonymity managing means when having received a communication connection request designating the callee device from the caller device; a notifying means for acquiring the anonymity of at least one of the caller device and the callee device from the foregoing acquired anonymity management information and notifying it to the caller device; and a communication establishing means for, when establishing the communication session between the caller device and the callee device, deciding which address, out of the real address and the anonymous address, should be used as an address of the caller device to be notified to the callee device responding to the anonymity of the caller device to be included in the foregoing acquired anonymity management information.

A third aspect of the present invention is characterized in that in the above-mentioned aspect, the foregoing anonymous communication establishing means includes a response receiving means for receiving a response to the notification by the foregoing notifying means from the foregoing caller device, and that the foregoing communication establishing means decides whether or not the foregoing communication session should be established based upon the response received by the foregoing response receiving means.

A fourth aspect of the present invention is characterized in that in the above-mentioned aspect, the foregoing communication establishing means establishes the foregoing communication session when the response received by the foregoing response receiving means is a permission response.

A fifth aspect of the present invention is characterized in that in the above-mentioned aspect, the foregoing communication establishing means does not establish the foregoing communication session when the response received by the foregoing response receiving means is a no-permission response.

A sixth aspect of the present invention, which is an anonymous communication method enabling a communication by anonymity, is characterized in detecting anonymities of communication parties when establishing a communication session, and notifying them to a communication device of a caller.

A seventh aspect of the present invention is characterized in, in the above-mentioned aspect, including: (a) an anonymity management information acquiring step in which an anonymous communication establishing means acquires anonymity management information of a caller device and anonymity management information of a callee device from an anonymity managing means retaining anonymity management information including a real address, an anonymous address, and an anonymity of a communication device when having received a communication connection request designating the callee device from the caller device; (b) a notifying step in which the foregoing anonymous communication establishing means acquires the anonymity of at least one of the caller device and the callee device from the foregoing acquired anonymity management information and notifies it to the caller device; and (c) a communication establishing step in which the foregoing anonymous communication establishing means decides which address, out of the real address and the anonymous address, should be used as an address of the caller device to be notified to the callee device responding to the anonymity of the caller device to be included in the foregoing acquired anonymity management information when establishing the communication session between the caller device and the callee device.

An eighth aspect of the present invention, which is an anonymous communication establishing apparatus to be installed in an anonymous communication system enabling a communication by anonymity, is characterized in detecting anonymities of communication parties when establishing a communication session, and notifying them to a communication device of a caller.

A ninth aspect of the present invention is characterized in, in the above-mentioned aspect, including: an anonymity management information acquiring means for acquiring anonymity management information of a caller device and anonymity management information of a callee device from an anonymity managing means retaining anonymity management information including a real address, an anonymous address, and an anonymity of the communication device when having received a communication connection request designating the callee device from the caller device; a notifying means for acquiring the anonymity of at least one of the caller device and the callee device from the foregoing acquired anonymity management information and notifying it to the caller device; and a communication establishing means for, when establishing the communication session between the caller device and the callee device, deciding which address, out of the real address and the anonymous address, should be used as an address of the caller device to be notified to the callee device responding to the anonymity of the caller device to be included in the foregoing acquired anonymity management information.

A tenth aspect of the present invention is characterized in, in the above-mentioned aspect, including a response receiving means for receiving a response to the notification by the foregoing notifying means from the foregoing caller device, wherein the foregoing communication establishing means decides whether or not the foregoing communication session should be established based upon the response received by the foregoing response receiving means.

An eleventh aspect of the present invention, which is a communication device in an anonymous communication system including: an anonymity managing means for retaining anonymity management information including a real address, an anonymous address, and an anonymity of a communication device; and an anonymous communication establishing means for establishing a communication session between the communication devices that includes: an anonymity management information acquiring means for acquiring anonymity management information of a caller device and anonymity management information of a callee device from the foregoing anonymity managing means when having received a communication connection request designating the callee device from the caller device; a notifying means for acquiring the anonymity of at least one of the caller device and the callee device from the foregoing acquired anonymity management information and notifying it to the caller device; and a communication establishing means for, when establishing the communication session between the caller device and the callee device, deciding which address, out of the real address and the anonymous address, should be used as an address of the caller device to be notified to the callee device responding to the anonymity of the caller device to be included in the foregoing acquired anonymity management information, is characterized in including a means for receiving a notification from the foregoing notifying means, and outputting notification contents in one of a character output form, a voice output form, and a vibration output form, or a plurality of output forms.

A twelfth aspect of the present invention, which is a communication device in an anonymous communication system including: an anonymity managing means for retaining anonymity management information including a real address, an anonymous address, and an anonymity of a communication device; and an anonymous communication establishing means for establishing a communication session between the communication devices that includes: an anonymity management information acquiring means for acquiring anonymity management information of a caller device and anonymity management information of a callee device from the foregoing anonymity managing means when having received a communication connection request designating the callee device from the caller device; a notifying means for acquiring the anonymity of at least one of the caller device and the callee device from the foregoing acquired anonymity management information and notifying it to the caller device; a response receiving means for receiving a response to the notification by the above notifying means from the caller device; and a communication establishing means for deciding whether the communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in the foregoing acquired anonymity management information, is characterized in including: a means for receiving a notification from the foregoing notifying means, and outputting notification contents in one of a character output form, a voice output form, and a vibration output form, or a plurality of output forms; and a means for transmitting the response corresponding to the foregoing notification to the foregoing response receiving means.

A thirteenth aspect of the present invention causes a computer to function as: an anonymity management information acquiring means for acquiring anonymity management information of a caller device and anonymity management information of a callee device from an anonymity managing means for retaining anonymity management information including a real address, an anonymous address, and an anonymity of a communication device when having received a communication connection request designating the callee device from the caller device; a notifying means for acquiring the anonymity of at least one of the caller device and the callee device from the foregoing acquired anonymity management information and notifying it to the caller device; and a communication establishing means for, when establishing a communication session between the caller device and the callee device, deciding which address, out of the real address and the anonymous address, should be used as an address of the caller device to be notified to the callee device responding to the anonymity of the caller device to be included in the foregoing acquired anonymity management information.

A fourteenth aspect of the present invention causes a computer to function as: an anonymity management information acquiring means for acquiring anonymity management information of a caller device and anonymity management information of a callee device from an anonymity managing means for retaining anonymity management information including a real address, an anonymous address, and an anonymity of a communication device when having received a communication connection request designating the callee device from the caller device; a notifying means for acquiring the anonymity of at least one of the caller device and the callee device from the foregoing acquired anonymity management information and notifying it to the caller device; a response receiving means for receiving a response to the notification by the above notifying means from the foregoing caller device; and a communication establishing means for deciding whether a communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in the foregoing acquired anonymity management information.

A fifteenth aspect of the present invention causes a computer constituting a communication device in an anonymous communication system including: an anonymity managing means for retaining anonymity management information including a real address, an anonymous address, and an anonymity of a communication device; and an anonymous communication establishing means for establishing a communication session between the communication devices, which includes: an anonymity management information acquiring means for acquiring anonymity management information of a caller device and anonymity management information of a callee device from the foregoing anonymity managing means when having received a communication connection request designating the callee device from the caller device; a notifying means for acquiring the anonymity of at least one of the caller device and the callee device from the foregoing acquired anonymity management information and notifying it to the caller device; and a communication establishing means for, when establishing a communication session between the caller device and the callee device, deciding which address, out of the real address and the anonymous address, should be used as an address of the caller device to be notified to the callee device responding to the anonymity of the caller device to be included in the foregoing acquired anonymity management information, to function as a means for receiving a notification from the foregoing notifying means, and outputting notification contents in one of a character output form, a voice output form, and a vibration output form, or a plurality of output forms.

A sixteenth aspect of the present invention causes a computer constituting a communication device in an anonymous communication system including: an anonymity managing means for retaining anonymity management information including a real address, an anonymous address, and an anonymity of a communication device; and an anonymous communication establishing means for establishing a communication session between the communication devices, which includes: an anonymity management information acquiring means for acquiring anonymity management information of a caller device and anonymity management information of a callee device from the foregoing anonymity managing means when having received a communication connection request designating the callee device from the caller device; a notifying means for acquiring the anonymity of at least one of the caller device and the callee device from the foregoing acquired anonymity management information and notifying it to the caller device; a response receiving means for receiving a response to the notification by the above notifying means from the caller device; and a communication establishing means for deciding whether the communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in the foregoing acquired anonymity management information, to function as: a means for receiving a notification from the foregoing notifying means, and outputting notification contents in one of a character output form, a voice output form, and a vibration output form, or a plurality of output forms; and a means for transmitting the response corresponding to the foregoing notification to the foregoing response receiving means.

Above, while the present invention has been particularly shown and described with reference to exemplary embodiments and exemplary examples thereof, the present invention is not limited to the above-mentioned exemplary embodiments and exemplary examples. It will be understood by those of ordinary skill in the art that various changes in form and details may be made therein without departing from the spirit and scope of the present invention as defined by the claims.

This application is based upon and claims the benefit of priority from Japanese patent application No. 2008-197944, filed on Jul. 31, 2008, the disclosure of which is incorporated herein in its entirety by reference.

### REFERENCE SIGNS LIST

100 and 200 anonymous communication systems

110 and 111 communication devices

120 anonymity managing apparatus

130 anonymous communication establishing apparatus

140 network

1. An anonymous communication system enabling a communication by anonymity, said anonymous communication system detecting anonymities of communication parties when establishing a communication session, and notifying them to a communication device of a caller.

2. An anonymous communication system according to claim 1, comprising an anonymity managing means for retaining anonymity management information including a real address, an anonymous address and an anonymity of a communication device, and an anonymous communication establishing means for establishing a communication session between the communication devices, wherein said anonymous communication establishing means comprises:
an anonymity management information acquiring means for acquiring anonymity management information of a caller device and anonymity management information of a callee device from said anonymity managing means when having received a communication connection request designating the callee device from the caller device;
a notifying means for acquiring the anonymity of at least one of the caller device and the callee device from said acquired anonymity management information and notifying it to the caller device; and
a communication establishing means for, when establishing the communication session between the caller device and the callee device, deciding which address, out of the real address and the anonymous address, should be used as an address of the caller device to be notified to the callee device responding to the anonymity of the caller device to be included in said acquired anonymity management information.

3. An anonymous communication system according to claim 2:
wherein said anonymous communication establishing means comprises a response receiving means for receiving a response to the notification by said notifying means from said caller device; and
wherein said communication establishing means decides whether or not said communication session should be established based upon the response received by said response receiving means.

4. An anonymous communication system according to claim 3, wherein said communication establishing means establishes said communication session when the response received by said response receiving means is a permission response.

5. An anonymous communication system according to claim 3, wherein said communication establishing means does not establish said communication session when the response received by said response receiving means is a no-permission response.

6. An anonymous communication method enabling a communication by anonymity, said anonymous communication method detecting anonymities of communication parties when establishing a communication session, and notifying them to a communication device of a caller.

7. An anonymous communication method according to claim 6, comprising:
(a) an anonymity management information acquiring step in which an anonymous communication establishing means acquires anonymity management information of a caller device and anonymity management information of a callee device from an anonymity managing means retaining anonymity management information including a real address, an anonymous address, and an anonymity of a communication device when having received a communication connection request designating the callee device from the caller device;
(b) a notifying step in which said anonymous communication establishing means acquires the anonymity of at least one of the caller device and the callee device from said acquired anonymity management information and notifies it to the caller device; and
(c) a communication establishing step in which said anonymous communication establishing means decides which address, out of the real address and the anonymous address, should be used as an address of the caller device to be notified to the callee device responding to the anonymity of the caller device to be included in said acquired anonymity management information when establishing the communication session between the caller device and the callee device.

8. An anonymous communication establishing apparatus to be installed in an anonymous communication system enabling a communication by anonymity, said anonymous communication establishing apparatus detecting anonymities of communication parties when establishing a communication session, and notifying them to a communication device of a caller.

9. An anonymous communication establishing apparatus according to claim 8, comprising:
an anonymity management information acquiring means for acquiring anonymity management information of the caller device and anonymity management information of a callee device from an anonymity managing means retaining anonymity management information including a real address, an anonymous address, and an anonymity of the communication device when having received a communication connection request designating the callee device from the caller device;
a notifying means for acquiring the anonymity of at least one of the caller device and the callee device from said acquired anonymity management information and notifying it to the caller device; and
a communication establishing means for, when establishing the communication session between the caller device and the callee device, deciding which address, out of the real address and the anonymous address, should be used as an address of the caller device to be notified to the callee device responding to the anonymity of the caller device to be included in said acquired anonymity management information.

10. An anonymous communication establishing apparatus according to claim 9, comprising a response receiving means for receiving a response to the notification by said notifying means from said caller device, wherein said communication establishing means decides whether or not said communication session should be established based upon the response received by said response receiving means.

11. A communication device in an anonymous communication system comprising: an anonymity managing means for retaining anonymity management information including a real address, an anonymous address, and an anonymity of a communication device; and an anonymous communication establishing means for establishing a communication session between the communication devices, said anonymous communication establishing means comprising: an anonymity management information acquiring means for acquiring anonymity management information of a caller device and anonymity management information of a callee device from said anonymity managing means when having received a communication connection request designating the callee device from said caller device; a notifying means for acquiring the anonymity of at least one of the caller device and the callee device from said acquired anonymity management information and notifying it to the caller device; and a communication establishing means for, when establishing the communication session between the caller device and the callee device, deciding which address, out of the real address and the anonymous address, should be used as an address of the caller device to be notified to the callee device responding to the anonymity of the caller device to be included in said acquired anonymity management information, said communication device comprising a means for receiving a notification from said notifying means, and outputting notification contents in one of a character output form, a voice output form, a vibration output form, or a plurality of output forms.

12. A communication device in an anonymous communication system comprising: an anonymity managing means for retaining anonymity management information including a real address, an anonymous address, and an anonymity of a communication device; and an anonymous communication establishing means for establishing a communication session between the communication devices, said anonymous communication establishing means comprising: an anonymity management information acquiring means for acquiring anonymity management information of a caller device and anonymity management information of a callee device from said anonymity managing means when having received a communication connection request designating the callee device from said caller device; a notifying means for acquiring the anonymity of at least one of the caller device and the callee device from said acquired anonymity management information and notifying it to the caller device; a response receiving means for receiving a response to the notification by the above notifying means from the caller device; and a communication establishing means for deciding whether the communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in said acquired anonymity management information, said communication device comprising:
a means for receiving a notification from said notifying means, and outputting notification contents in one of a character output form, a voice output form, and a vibration output form, or a plurality of output forms; and
a means for transmitting the response corresponding to said notification to said response receiving means.

13. A program for causing a computer to function as:
an anonymity management information acquiring means for acquiring anonymity management information of a caller device and anonymity management information of a callee device from an anonymity managing means for retaining anonymity management information including a real address, an anonymous address, and an anonymity of a communication device when having received a communication connection request designating the callee device from the caller device;
a notifying means for acquiring the anonymity of at least one of the caller device and the callee device from said acquired anonymity management information and notifying it to the caller device; and
a communication establishing means for, when establishing a communication session between the caller device and the callee device, deciding which address, out of the real address and the anonymous address, should be used as an address of the caller device to be notified to the callee device responding to the anonymity of the caller device to be included in said acquired anonymity management information.

14. A program for causing a computer to function as:
an anonymity management information acquiring means for acquiring anonymity management information of a caller device and anonymity management information of a callee device from an anonymity managing means for retaining anonymity management information including a real address, an anonymous address, and an anonymity of a communication device when having received a communication connection request designating the callee device from the caller device;
a notifying means for acquiring the anonymity of at least one of the caller device and the callee device from said acquired anonymity management information and notifying it to the caller device;
a response receiving means for receiving a response to the notification by the above notifying means from said caller device; and
a communication establishing means for deciding whether a communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in said acquired anonymity management information.

15. A program for causing a computer constituting a communication device in an anonymous communication system comprising: an anonymity managing means for retaining anonymity management information including a real address, an anonymous address, and an anonymity of a communication device; and an anonymous communication establishing means for establishing a communication session between the communication devices, said anonymous communication establishing means comprising: an anonymity management information acquiring means for acquiring anonymity management information of a caller device and anonymity management information of a callee device from said anonymity managing means when having received a communication connection request designating the callee device from the caller device; a notifying means for acquiring the anonymity of at least one of the caller device and the callee device from said acquired anonymity management information and notifying it to the caller device; and a communication establishing means for, when establishing a communication session between the caller device and the callee device, deciding which address, out of the real address and the anonymous address, should be used as an address of the caller device to be notified to the callee device responding to the anonymity of the caller device to be included in said acquired anonymity management information, to function as a means for receiving a notification from said notifying means, and outputting notification contents in one of a character output form, a voice output form, and a vibration output form, or a plurality of output forms.

16. A program for causing a computer constituting a communication device in an anonymous communication system comprising: an anonymity managing means for retaining anonymity management information including a real address, an anonymous address, and an anonymity of a communication device; and an anonymous communication establishing means for establishing a communication session between the communication devices, said anonymous communication establishing means comprising: an anonymity management information acquiring means for acquiring anonymity management information of a caller device and anonymity management information of a callee device from said anonymity managing means when having received a communication connection request designating the callee device from the caller device; a notifying means for acquiring the anonymity of at least one of the caller device and the callee device from said acquired anonymity management information and notifying it to the caller device; a response receiving means for receiving a response to the notification by the above notifying means from the caller device; and a communication establishing means for deciding whether the communication session between the caller device and the callee device should be established based upon the response received by the above response receiving means, and when establishing the communication session, deciding which address, out of the real address and the anonymous address, should be used as an address of the caller device to be notified to the callee device responding to the anonymity of the caller device to be included in said acquired anonymity management information, to function as:
a means for receiving a notification from said notifying means, and outputting notification contents in one of a character output form, a voice output form, and a vibration output form, or a plurality of output forms; and
a means for transmitting the response corresponding to said notification to said response receiving means.
